(19) United States
(12) Patent Application Publication
(10) Pub. No.: US 2007/0085758 A1
(43) Pub. Date: Apr. 19, 2007

(54) DISPLAY APPARATUS AND METHOD USED IN A HAND-HELD DEVICE

(75) Inventors: Wen-Chuan Lian, Shenzhen (CN); Duo Liu, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,470

(22) Filed: Aug. 10, 2006

(30) Foreign Application Priority Data
Oct. 19, 2005 (CN) 200510100555.4

(51) Int. Cl. G09G 5/00

(52) U.S. Cl. 345/1.1

(57) ABSTRACT

A display apparatus used in a hand-held device is provided. The display apparatus includes a primary display, a secondary display, a plurality of input devices, and a processing unit. The primary display is a non-volatile display, and the secondary display is a volatile display. The input devices are for operational inputs. The input devices include a first input device and a second input device. The first input device is for updating a detailed view information displayed on the primary display, and the second input device is for confirming operational inputs on the input devices. The processing unit displays a preview information on the secondary display in response to the operational input of the first input device, and updates the primary display with the detailed view information corresponding the preview information in response to the operational input of the second input device. A related method is also provided.

### TECHNICAL FIELD

The present invention relates to display apparatuses and methods therefor, and particularly to a display apparatus and method used in a hand-held device such as an electronic book reading device.

### GENERAL BACKGROUND

With the fast development in electronic technologies, a large number of hand-held electronic devices have been introduced in the electronics consumer market, products such as mobile phone, personal digital assistant (PDA), electronic book reading device, readily satisfying a business requirement or an amusement requirement. These available hand-held devices are mainly used for displaying visual messages that include graphics and text data as well as a means to access and manipulate such messages. Therefore, in order to display these visual messages, each hand-held device provides one or more displays therein.

Accordingly, the hand-held device can display information, such as time, date, power consumption, schedule, incoming-calls, messages, etc., through the display(s). However, the hand-held device has a high power consumption when using a volatile display for information display. That is, the hand-held device has to maintain the display power to be on in order to display the information.

Therefore, in order to solve the largely power consumption, some hand-held devices (e.g., electronic book reading devices) use a non-volatile display instead for information display. Accordingly, the hand-held devices can display the information without power consumption. However, these hand-held devices have slow response speed due that the non-volatile display has a relatively lower response speed compared to the volatile display.

What is needed, therefore, is a display apparatus and method used in a hand-held device, which not only has a relatively higher response speed, but also can reduce power consumption.

### SUMMARY

A display apparatus used in a hand-held device is provided. The display apparatus includes a primary display and a secondary display. The primary display is preferably a non-volatile display for displaying a detailed view information stored in the hand-held device. The secondary display is preferably a volatile display for displaying real-time information of the hand-held device.

A display method used in a hand-held device is also provided. The method includes the steps of: (a) providing a primary display and a secondary display, the primary display is a non-volatile display, and the secondary display is a volatile display; (b) providing a first input device and a second input device for operational inputs, the first input device is for updating a detailed view information displayed on the primary display, and the second input device is for confirming the operational input of the first input device; (c) displaying real-time information of the hand-held device on the secondary display; (d) displaying a preview information on the secondary display, in response to the operational input of the first input device; (e) updating the detailed view information displayed on the primary display with the detailed view information that corresponds to the preview information, in response to the operational input of the second input device; and (f) powering off the primary display after updating the detailed view information thereon.

Other advantages and novel features will be drawn from the following detailed description with reference to the attached drawing, in which:

### BRIEF DESCRIPTION OF DRAWINGS

FIG. 1 is a schematic diagram of a hardware infrastructure of a display apparatus used in a hand-held device in accordance with a preferred embodiment of the present invention; and

FIG. 2 is a flowchart of a preferred display method used in a hand-held device by utilizing the display apparatus of FIG. 1.

### DETAILED DESCRIPTION

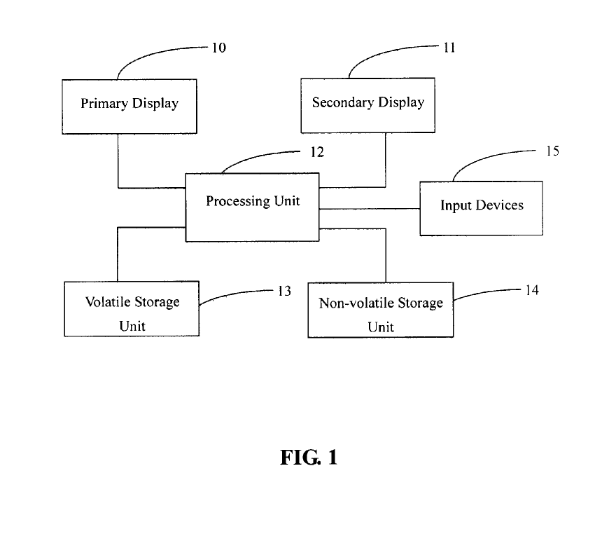

FIG. 1 is a schematic diagram of a hardware infrastructure of a display apparatus in accordance with a preferred embodiment of the present invention. The display apparatus can be incorporated into a hand-held device such as, for example, electronic book reading device, personal digital assistant, etc, for displaying information of the hand-held device. The display apparatus mainly includes a primary display 10, a secondary display 11, a processing unit 12, and a plurality of input devices 15.

The primary display 10 is preferably a non-volatile display such as an Electronic Ink (E-Ink) display, whereas the secondary display 11 is preferably a volatile display such as a Thin Film Transistor Liquid Crystal Display (TFT LCD). Therefore, the primary display 10 is capable of displaying information after being powered off. In addition, the primary display 10 is relatively larger than the secondary display in size. The secondary display 11 displays real-time information of the hand-held device. The real-time information may include, for example, such as a system time, a chapter of information displayed on the primary display 10, a page number of information displayed on the primary display 10, and the like.

The input devices 15 are for operational inputs such as, for example updating information displayed on the primary display 10, confirming operational inputs, and so on. Therefore, the input devices 15 include a first input device for updating information to be displayed on the primary display 10 and a second input device for confirming operational inputs.

The processing unit 12 controls the displays in response to the operational inputs on the input devices 15. For example, in response to the operational input of the first input device, the processing unit 12 displays a preview information corresponding the operational input of the first input device on the secondary display 11; in response to the operational input of the second input device, the processing unit 12 updates the primary display 10 with a detailed view information corresponding the preview information thereon, and further redisplays the real-time information of the hand-held device on the secondary display 11. Furthermore, the processing unit 12 also powers off the primary display 10 after updating the detailed view information thereon, thereby reducing power consumption of the hand-held device.

In addition, the processing unit 12 performs other operations on the secondary display 11 in response to operational inputs on other input devices. Moreover, while performing other operations on the secondary display 11, the processing unit can also maintain power off on the primary display 10.

Therefore, by utilizing the display apparatus, the hand-held device can display information on the primary display 10 without having power consumption thereon until required updating the information on the primary display 10, and simultaneously perform any operations on the secondary display 11. Furthermore, the primary display 10 is in a larger size and having relatively lower response speed, and the secondary display 11 is in a smaller size and having relatively higher response speed, therefore, the hand-held device not only can enhance a response speed, but can also reduce power consumption thereof.

The display apparatus further includes a volatile storage unit 13 and a non-volatile storage unit 14. The volatile storage unit 13 may be a Random Access Memory (RAM) for storing information required or generated during an operation on the hand-held device. The non-volatile storage unit 14 may be a Read Only Memory (ROM) or a Flash.

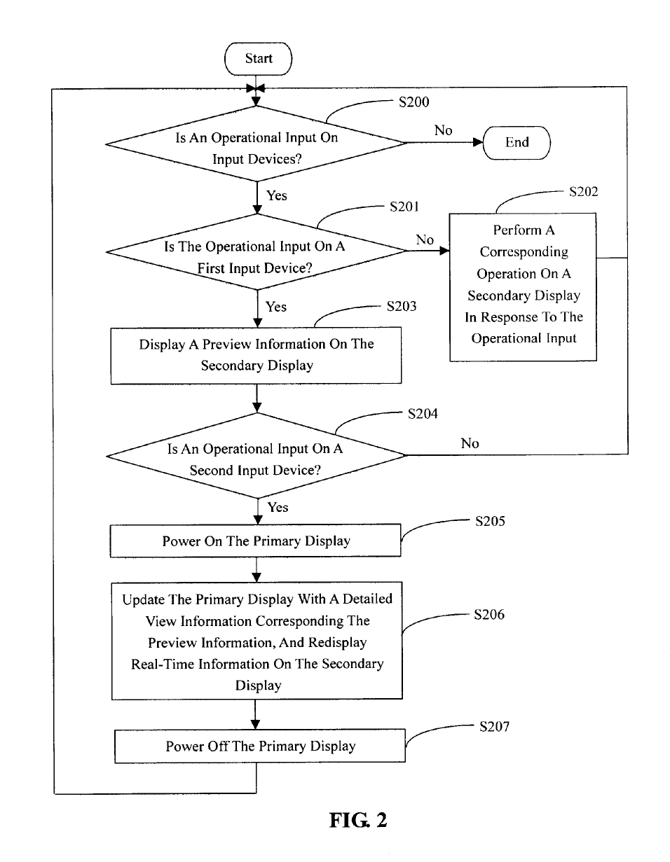

FIG. 2 is a flowchart of a preferred display method used in a hand-held device by utilizing the display apparatus of FIG. 1. In step S200, the processing unit 12 determines whether it receives an operational input of the input devices 15. If not, the procedure is finished. If so, in step S201, the processing unit 12 determines whether the operational input is on the first input device.

If the operational input is not on the first input device, in step S202, the processing unit 12 performs the corresponding operation on the secondary display 11 in response to the operational input.

If the operational input is on the first input device, in step S203, the processing unit 12 displays the preview information corresponding the operational input of the first input device on the secondary display 11.

In step S204, the processing unit 12 determines whether it further receives an operational input of the second input device. If not, the procedure goes to step S200 described above. If so, in step S205, the processing unit 12 powers on the primary display 10.

In step S206, the processing unit 12 updates the primary display 10 with the detailed view information corresponding the preview information to be displayed thereon, and redisplays real-time information of the hand-held device on the secondary display 11.

In step S207, the processing unit powers off the primary display 10 after updating the detailed view information thereon.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. A display apparatus used in a hand-held device, the display apparatus comprising:
a primary display, wherein the primary display is a non-volatile display;
a secondary display, wherein the secondary display is a volatile display and is for displaying real-time information of the hand-held device;
a plurality of input devices for operational inputs, the input devices including a first input device and a second input device, the first input device for updating a detailed view information displayed on the primary display, and the second input device for confirming operational inputs on the input devices; and
a processing unit for controlling the displays in response to the operational inputs on the input devices, wherein the processing unit displays a preview information on the secondary display in response to the operational input of the first input device, and updates the primary display with the detailed view information corresponding the preview information in response to the operational input of the second input device.

2. The display apparatus according to claim 1, wherein the processing unit further redisplays the real-time information of the hand-held device on the secondary display in response to the operational input of the second input device.

3. The display apparatus according to claim 2, wherein the real-time information comprises a system time, a chapter head of the information displayed on the primary display, and a page number of the information displayed on the primary display.

4. The display apparatus according to claim 1, wherein the processing unit further powers off the primary display after updating the detailed view information thereon.

5. A display apparatus used in a hand-held device, the display apparatus comprising:
a primary display for displaying a detailed view information stored in the hand-held device, wherein the primary display is a non-volatile display; and
a secondary display for displaying real-time information of the hand-held device, wherein the secondary display is a volatile display.

6. The display apparatus according to claim 5, wherein the real-time information comprises a system time, a chapter head of the information displayed on the primary display, and a page number of the information displayed on the primary display.

7. The display apparatus according to claim 5, further comprising a first input device and a second input device for operational inputs, the first input device for updating the detailed view information displayed on the primary display, and the second input device for confirming the operational input of the first input device.

8. The display apparatus according to claim 7, wherein the secondary display displays a preview information corresponding the operational input of the first input device.

9. The display apparatus according to claim 8, wherein the primary display updates the detailed view information displayed with the detailed view information that corresponds to the preview information corresponding the operational input of the second input device.

10. The display apparatus according to claim 9, wherein the primary display is powered off after updating the detailed view information thereon.

11. The display apparatus according to claim 9, wherein the secondary display redisplays the real-time information of the hand-held device corresponding the operational input of the second input device.

12. A display method used in a hand-held device, the display method comprising the steps of:
providing a primary display and a secondary display, wherein the primary display is a non-volatile display, and the secondary display is a volatile display;
providing a first input device and a second input device for operational inputs, wherein the first input device is for updating a detailed view information displayed on the primary display, and the second input device is for confirming the operational input of the first input device;
displaying real-time information of the hand-held device on the secondary display;
displaying a preview information on the primary display, in response to an operational input of the first input device;
updating the detailed view information displayed on the primary display with the detailed view information that corresponds to the preview information, in response to an operational input of the second input device; and
powering off the primary display after updating the detailed view information thereon.

13. The display method according to claim 12, further comprising the step of:
redisplaying the real-time information on the secondary display, in response to the operational input of the second input device.

14. The display method according to claim 13, wherein the real-time information comprises a system time, a chapter head of the information displayed on the primary display, and a page number of the information displayed on the primary display.
